(19) United States
(12) Patent Application Publication
(10) Pub. No.: US 2024/0296469 A1
(43) Pub. Date: Sep. 5, 2024

(54) SYSTEM, METHOD, AND COMPUTER PROGRAM PRODUCT FOR CONNECTING POLICE DEPARTMENTS AND THEIR COMMUNITIES

(71) Applicant: Tehra Emily Foster, Kansas City, MO (US)

(72) Inventor: Tehra Emily Foster, Kansas City, MO (US)

(21) Appl. No.: 18/177,271

(22) Filed: Mar. 2, 2023

(51) Int. Cl. G06Q 30/0203; G06Q 50/26

(52) U.S. Cl. CPC G06Q 30/0203; G06Q 50/26

(57) ABSTRACT

A computer implemented method collects survey data enhancing communication between an organization and its stakeholders. The method includes providing a computer user interface; presenting a survey; receiving and storing the survey responses from the respondent; analyzing the survey responses to determine results; and transmitting the results to the organization. The computer interface surveys a respondent selected from the stakeholders and receives survey responses from the respondent. The survey is selected to correlate to the respondent's role relative to the organization. The results include a numeric value for at least one subject category. A system for implementing the method includes a central server having data processor(s); a network connected to the server; respondent devices connected with the central server via the network; and a non-transitory computer-readable medium storing software. The software includes instructions which, when executed by the processing devices cause the processing devices to perform operations.

### BACKGROUND OF THE INVENTION

The present invention relates to law enforcement and, more particularly, to a communication tool that connects police departments and the communities they interact with.

Citizens don't trust their officers currently, and officers suffer from low morale and distrust within their police departments. Police departments have few options for identifying specific problems beyond commercially available surveys, such as Survey Monkey, which can only provide simple statistics based on the questions selected by the Department; none of these products develop solutions to trust and morale problems. Numbers have no call to action. There is no step beyond completing a survey.

As can be seen, there is a need for a solution to trust and morale problems as detailed herein. The present invention exceeds the capabilities of the prior art by quantifying data and providing solutions that are specific to the data configured.

### SUMMARY OF THE INVENTION

In one aspect of the present invention, a computer implemented method for collecting survey data enhancing communication between an organization and its stakeholders comprises providing a computer user interface configured to survey a respondent selected from the stakeholders and to receive survey responses from the respondent; presenting a survey selected to correlate to the respondent's role relative to the organization; receiving and storing the survey responses from the respondent; analyzing the survey responses to determine results including a numeric value for at least one subject category; and transmitting the results to the organization.

In another aspect of the present invention, a non-transitory computer-readable medium storing software comprises instructions executable by one or more processing devices which, upon such execution, cause the one or more processing devices to perform operations implementing the method.

In another aspect of the present invention, a system comprises a central server having one or more data processors; a network in electronic communication with the central server; one or more respondent devices in electronic communication with the central server via the network; and a non-transitory computer-readable medium coupled to the one or more data processors having instructions stored thereon which, when executed by the one or more data processors, cause the one or more data processors to perform operations implementing the method.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a flow chart of a web portal process according to an embodiment of the present invention;

FIG. 2 is a flow chart of a research cycle process according to an embodiment of the present invention;

FIG. 3 is a flow chart of an audit process according to an embodiment of the present invention;

FIG. 4 is a system view of an embodiment of the present invention, showing the communication between a user device and a central server; and

FIG. 5 is an exemplary computer system of the embodiment of the present invention.

### DETAILED DESCRIPTION OF THE INVENTION

With this overview in mind and turning now to a more detailed discussion in conjunction with the attached figures, the techniques of the present disclosure are illustrated as being implemented in a computing device such as a PC, laptop, tablet, smartphone or other device capable of executing computer-executed instructions stored on a non-transient medium, e.g., memory, such as random access memory (RAM), read-only memory (ROM), erasable programmable read-only memory (EPROM), flash memory and so on. Thus, the execution of steps in a process flow is by way of computer-execution of such steps, e.g., via a processor configured to retrieve the corresponding instructions from memory and execute them.

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

Broadly, one embodiment of the present invention is a system, method and computer program product that enables communication between a department and its stakeholders, including the communities they interact with and members of the department.

The present disclosure describes embodiments of the present invention for use with a police department. However, the inventive system, method, and software are not limited to use therewith. Any organization may benefit from analysis of employee morale and stakeholder trust.

The present invention creates transparency for citizens and officers to build trust, respect and relationships within the communities they serve as well as their own departments. Advantageously, and in stark contrast to the prior art, surveys submitted by citizens are analyzed in real time and the results are delivered directly to the police department. The present invention can also provide proven research to combat issues identified within departments. Furthermore, operators of the system of the present invention can implement department actions to improve service to the city and to better support their officers.

In order to achieve the goals described above, provided herein are system, method and/or computer program product embodiments, and/or combinations and sub-combinations thereof, for filling out a survey and automatically transmitting results to a police department.

The surveys comprise a set of questions that depends upon whether the respondent is a member of the community or a member of the department. Preferably, the questions are crafted to avoid leading the respondent to answer with a particular bias. Within a department, a baseline set of questions may be common to all respondents and additional questions may be selected to tailor the analysis to a sub-department. Multiple categories of questions are predetermined to measure a particular variable. For example, a survey may have 4 tiers of questions with 4 to 5 questions in each tier; e.g., x number of questions may be directed to employee morale, while y number of questions may address a level of trust in decision makers. The questions generally have a yes (or agree) or no (or disagree) response available. The questions in each category have a value adding to 100% for that category. For example, if a category has 5 questions, each “yes” response may contribute 20% to the value of that category, whereas a “no” response may contribute 0%. The questions may be framed as a statement to which the respondent agrees or disagrees.

Automated analysis of the collected responses may result in a report suggesting changes that may be made to improve future survey results. These changes may be compiled from research performed, for example using trial and error, to correlate variables to departmental success in various categories.

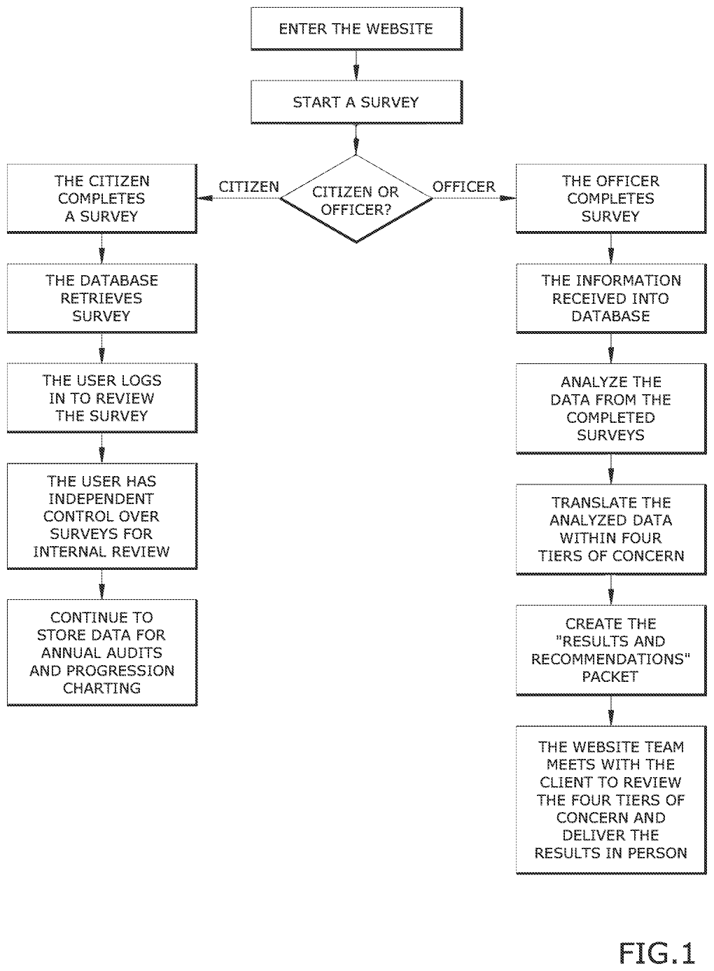

Turning to FIGS. 1 through 5, a survey and analysis system, method, and computer program are illustrated. FIG. 1 is a flow diagram of a process collecting, analyzing, and making recommendations from surveys, both of citizens and officers. The respondent may enter a website and start a survey, selecting from “citizen” or “officer”. If the respondent is a citizen, he or she completes the survey and the responses are stored to a database. The user, which may be, for example, a decision maker in the department and/or a consultant assisting the department, may log in to review individual survey responses with independent control. The data may be stored for future audits and progression charting. If the respondent is an officer, he or she completes the survey and the responses are stored to a database. The responses may be analyzed and translated to results in four tiers of concern. The analyzed data may be used to create a “results and recommendations” packet, providing direction to the department on how to improve. The administrators of the survey website may deliver the results in person to a department decision maker and review the results and recommendations with respect to the four tiers of concern.

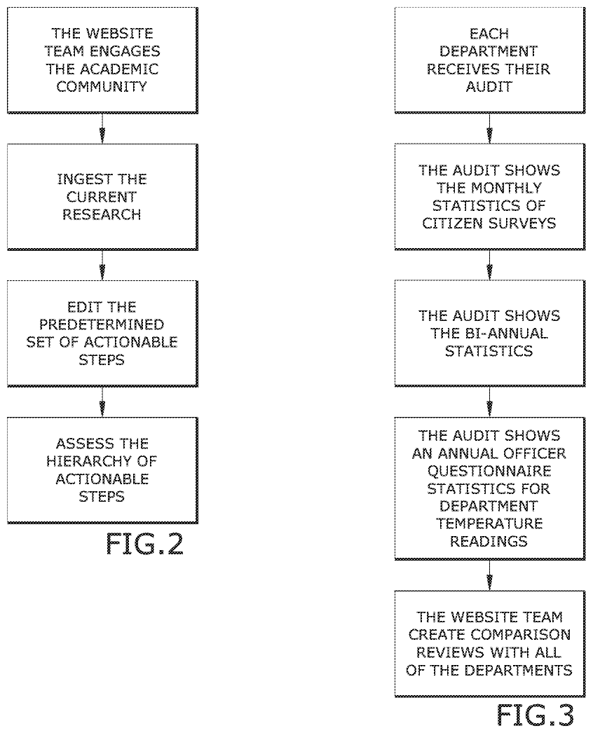

As shown in FIG. 2, the collected data may be used to contribute to current research, feedback from which may be used to edit a predetermined set of actionable steps that correlate to particular results. The hierarchy of the actionable steps may also be assessed.

FIG. 3 illustrates use of an audit showing monthly, bi-annual, and/or annual statistical analysis derived from the survey results. The audit may be tailored to each individual department. A report comparing the results may be prepared and discussed with department decision makers.

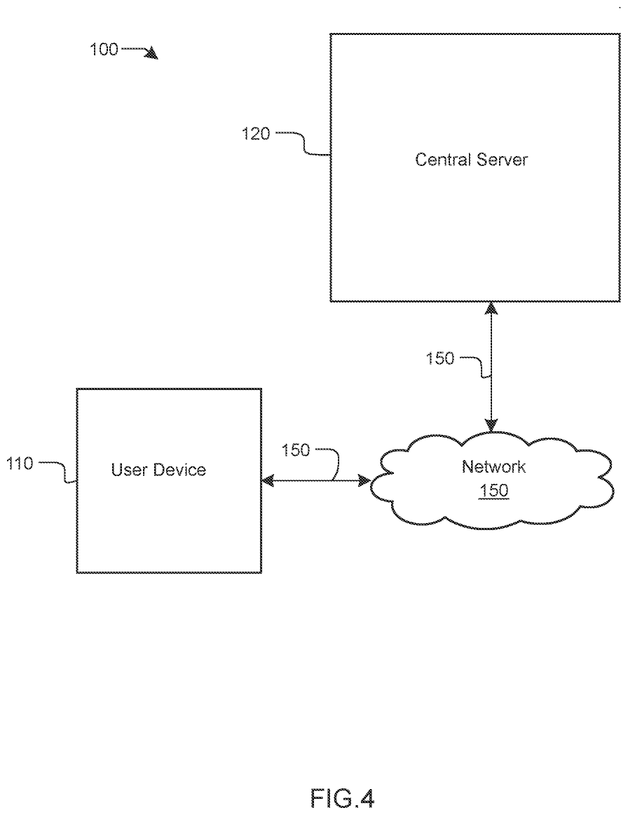

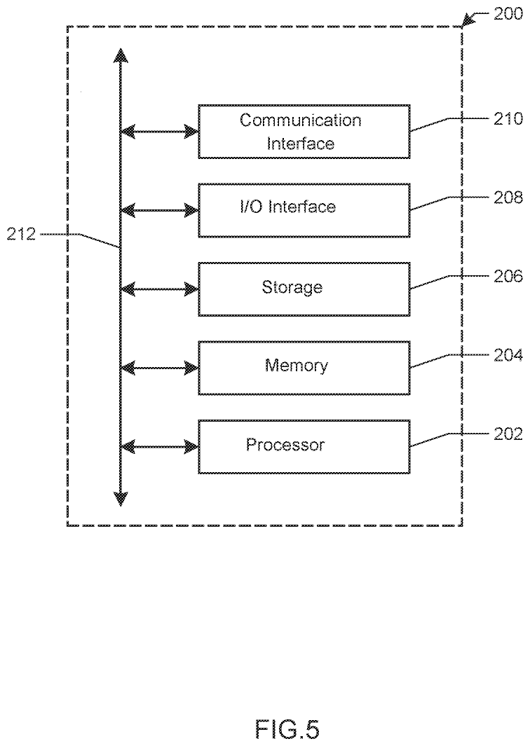

Making reference to FIGS. 4-5, a system 100 of the present invention is shown in FIG. 4, including an online portal that is accessed by a user via a device 110 to start or review a survey. The portal may be hosted on a central server 120 over a network 150. The central server 120 includes a computing system 200 (see FIG. 5) which includes, among other things, a processor 202 and a memory 204 coupled to the processor 202. The central server 120 includes a database (see Storage 206) for storing/accessing the surveys. The processor 202 is configured to execute instructions/tasks, such as the ones detailed below. The user may be a citizen, a police officer, or an analyst accessing results. Depending upon the selection made by the user on the user device 110, a customized survey is presented to the user.

Each user device 110 runs a user application (e.g., a browser accessing a portal or a mobile application) that connects to the central server 120 through the network 150. The network may be any communications network capable of transmitting data between computing devices, such as, but not limited to, a Wide Area Network (WAN), a Local Area Network (LAN), a Personal Area Network (PAN), wireless networks, the Internet, overlay networks, satellite networks, or any combination thereof. The user device 110 may be any computing device suitable for interacting with the central server 120, such as, but not limited to, a personal computer, laptop computer, mobile computer, smartphone or other mobile phone, personal digital assistant (PDA), or tablet computing device. The central server 120 may be any computing device or combinations thereof adequate to provide functionality described herein, such as, but not limited to, web servers, application servers, server computers, database systems, or any combination thereof.

The central server 120 is configured to generate and host portals that implement the methods of the present invention, such as a web-based portal or a website that hosts, stores, and transmits surveys and data associated with the surveys (described in greater detail below). Users register to gain access to the portal/website. The portal/website serves as a front end (graphical user interface) for viewing and completing a survey. Similarly, a mobile application platform may be hosted on the central server 120, configured to generate and host a mobile-based application that serves as the user front end after installed on a user device 110. A graphical user interface (GUI) may be generated by the central server 120 and the mobile application platform. The mobile application platform may be implemented using any appropriate technology, such as ANDROID™ or iOS™.

In the scenario where a user selects that they are a citizen, the citizen survey prompts the selection of a police department, after which selection they can complete the survey. The processor 202 analyzes the survey and the results are automatically sent directly, via the central server 120, to the selected police department for immediate access and review. If a citizen chooses to not remain anonymous, the department may directly engage the citizen for additional information/clarification.

In the scenario where a user selects that they are a police officer, the officer survey prompts the selection of a police department, after which time they can complete the survey. The officer survey remains anonymous and is translated to bring percentages to the police department to analyze how the department is doing in predetermined categories.

Citizen surveys submitted allow the department to review the information and determine if there is a problem or a need for follow-up with the citizen or the officer if applicable. If an investigation needs to take place, the survey can function as the jumping point for that investigation. Furthermore, the officer questionnaire may bring issues to light that negatively affect morale and compiled results may be relayed to the department, along with recommendations to resolve the identified issues to improve morale.

Over time, these functions working together will boost morale and trust within officers, which will help officers gain confidence and optimism to better serve the community, which in turn allows citizens to better trust and rely on their officers when they are needed.

FIG. 5 illustrates an example of a computing system 200 that may be embodied by the user device 110 and/or the central server 120. In certain embodiments, at least one computing system 200 performs at least one step of at least one method described or illustrated herein. In certain embodiments, at least one computing system 200 provides the functionality detailed. In certain embodiments, software running on at least one computing system 200 performs at least one step of at least one method detailed herein or provides functionality detailed herein. Certain embodiments include one or more portions of one or more computing systems 200. As used herein, reference to a computing system may include a computing device, and vice versa, where appropriate. Further, reference to a computing system may include one or more computing systems, where appropriate.

The present disclosure envisions any suitable number of computing systems 200 to implement the above-discussed system 100. It also contemplates the computing system 200 taking any appropriate physical form. In exemplary embodiments, the computing system 200 may be a desktop computer system, an embedded computer system, a laptop computer system, a mobile telephone (e.g., a smartphone), a PDA, a mainframe, a server, a tablet computing device, or combinations thereof. Where appropriate, the computing system 200 may include one or more computing systems 200; be unified or distributed; be provided in multiple locations; be provided across a plurality of machines; be provided across a plurality of data centers; or reside in a cloud (which may include at least one cloud component in at least one network). Where appropriate, one or more computing systems 200 may perform without substantial temporal or spatial limitation at least one step of one or more methods/processes detailed herein.

In certain embodiments, the computing system 200 includes a processor 202, memory 204, storage 206, an input/output (I/O) interface 208, a communication interface 210, and a bus 212. The present disclosure contemplates any suitable computer system having any suitable number of any suitable components in any suitable arrangement. In certain embodiments, the processor 202 includes hardware for executing instructions, such as those that define a computer program, and the present disclosure envisions use of any processor suitable to perform the functions discussed. In certain embodiments, memory 204 includes main memory for storing processor instructions for execution or data for the processor 202 to operate on, and the present disclosure envisions any suitable memory. In certain embodiments, storage 206 includes mass storage for data or instructions, and the present disclosure envisions any suitable storage. In certain embodiments, I/O interface 208 includes software, hardware, or both, providing one or more interfaces for communication between computing system 200 and one or more I/O devices. Computing system 200 may include one or more of these I/O devices, where appropriate. One or more of these I/O devices may facilitate communication between a computing system 200 and a user. The present disclosure envisions any suitable I/O interface. In certain embodiments, the communication interface 210 includes software, hardware, or both providing one or more interfaces for communication between the computing system 200 and one or more other computing systems 200 or one or more networks 150. The present disclosure envisions any appropriate network 150 (e.g., a wireless or wired network) and any appropriate communication interface 210 for it. In certain embodiments, bus 212 includes software, hardware, or both coupling components of computing system 200 to each other, and this disclosure contemplates any appropriate bus (or other form of interconnection).

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

What is claimed is:

1. A computer implemented method for collecting survey data enhancing communication between an organization and its stakeholders, comprising:
providing a computer user interface configured to survey a respondent selected from the stakeholders, having a role relative to the organization, and to receive survey responses from the respondent;
presenting a survey selected to correlate to the respondent's role;
receiving and storing the survey responses from the respondent;
analyzing the survey responses to determine results including a numeric value for at least one subject category; and
transmitting the results to the organization.

2. The computer implemented method of claim 1, further comprising:
hosting a web-based portal having the computer user interface.

3. The computer implemented method of claim 1, further comprising:
registering the respondent prior to presenting the survey.

4. The computer implemented method of claim 1, further comprising:
producing a report to the organization recommending a predetermined set of actionable steps based on the numeric value.

5. The computer implemented method of claim 1, further comprising:
auditing the survey responses from a plurality of respondents; and
producing a report containing statistical analysis of the survey responses over time.

6. The computer implemented method of claim 1, wherein the at least one subject category comprises four tiers of concern.

7. The computer implemented method of claim 1, wherein the organization is a police department.

8. A non-transitory computer-readable medium storing software comprising instructions executable by one or more processing devices which, upon such execution, cause the one or more processing devices to perform operations implementing the method of claim 1.

9. A system comprising:
a central server having one or more data processors;
a network in electronic communication with the central server;
one or more respondent devices in electronic communication with the central server via the network; and
a non-transitory computer-readable medium coupled to the one or more data processors having instructions stored thereon which, when executed by the one or more data processors, cause the one or more data processors to perform operations implementing the method of claim 1.

10. The system of claim 9, wherein the one or more respondent devices is a mobile device and the one or more data processors implement the method by way of a mobile application.
